(19) United States
(12) Patent Application Publication
(10) Pub. No.: US 2002/0064604 A1
(43) Pub. Date: May 30, 2002

(54) Capacitive sensor for detecting bubbles in SOG

(75) Inventors: Soon Chye Chan, Johor Bahru (MY); Bak Hong Chia, Singapore (SG)

Correspondence Address: STEPHEN B. ACKERMAN, 20 MCINTOSH DRIVE, POUGHKEEPSIE, NY, 12603, US

(73) Assignee: Chartered Semiconductor Manufacturing Ltd

(21) Appl. No.: 09/726,659

(22) Filed: Nov. 30, 2000

(51) Int. Cl. C08J 7/04

(52) U.S. Cl. 427/498; 118/712; 427/512

(57) ABSTRACT

A spin-on-glass delivery system has the invention's capacitive sensor to detect gas bubbles in a SOG tube. A SOG bottle is provided. The SOG bottle contains SOG. A N₂ gas supply is connected to the pressure tank by a pressure tube wherein the N₂ gas supply pressurizes the inside of the SOG bottle with N₂ gas. The SOG bottle is connected to SOG tube. In a key feature, a capacitive sensor is mounted on the SOG tube. The capacitive sensor detects gas bubbles in the SOG flowing through the SOG tube. The SOG tube is connected to a nozzle in a SOG tool. The SOG flows through the nozzle over to a wafer. A key point of the invention is to use a capacitive sensor to detect gas bubbles in spin-on-glass flowing through a SOG tube. This is a new, unsuggested use for the capacitive sensor. The prior art bubble sensors are optical sensors.

### BACKGROUND OF THE INVENTION

1. Field of the Invention

This invention relates generally to spin-on-glass (SOG) spin coating tools used in the fabrication of semiconductor devices and more particularly to a capacitive sensor in SOG tubing used to detect gas bubbles in spin-on-glass flowing through the SOG tubing.

2. Description of the Prior Art

Spin-on-glass tools are used to coat semiconductor structures with spin-on-glass. It is critical that the SOG does not contain any gas bubbles. Gas bubbles in SOG will reduce the quality of the SOG layer formed over the wafers and will reduce yields.

In the industry, it is common to use optical sensors to detect foreign bodies in the SOG flow. However, the inventor has found that the optical sensors need to be improved upon to increase the sensitivity and lower their costs and maintenance frequency.

This invention uses a capacitive sensor to detect bubbles in SOG flows.

The importance of overcoming the various deficiencies noted above is evidenced by the extensive technological development directed to the subject, as documented by the relevant patent and technical literature. The closest and apparently more relevant technical developments in the patent literature can be gleaned by considering U.S. Pat. No. 6,024,249 (On) that shows an optical sensor for detecting bubbles in a SOG line.

U.S. Pat. No. 5,089,305 (Ushijima et al.) (assigned to TEL) shows a SOG /photoresist tool.

U.S. Pat. No. 6,010,570 (Motada et al.), U.S. Pat. No. 5,688,322 (Motad et al.) and U.S. Pat. No. 5,925,410 (Akram) show other SOG tools and processes.

Rechner Industrie technical literature entitled “DC capacitive sensors” , Technical Data series 40 shows technical data for capacitive sensors.

### SUMMARY OF THE INVENTION

It is an object of the present invention to provide a capacitive sensor that detects bubbles in SOG flows.

It is an object of the present invention to provide a capacitive sensor that detects bubbles in SOG flows in a spin-on-glass tool for semiconductor manufacturing.

It is an object of the present invention to provide a capacitive sensor that detects bubbles in SOG flows in a spin-on-glass tool and stops the tool operation when bubble are detected.

It is an object of the present invention to provide a capacitive sensor that detects bubbles in SOG flows in a spin-on-glass tool in a TEL MK-8 SOG tool.

To accomplish the above objectives, the present invention provides a capacitive sensor for detecting bubbles in SOG flows preferably in a SOC line connected to a SOG tool.

A key point of the invention is to use a capacitive sensor to detect gas bubbles in spin-on-glass flowing through a SOG tube. This is a new, unsuggested use for a capacitive sensor. The prior art bubble sensors are optical sensors. The manufactures of the capacitive sensors do not suggest using the capacitive sensors to detect gas bubble in SOG flows.

A spin-on-glass delivery system has the invention's capacitive sensor unit to detect gas bubbles in a SOG tube. A SOG bottle is provided. The SOG bottle contains SOG. A N₂ gas supply is connected to the pressure tank by a pressure tube wherein the N₂ gas supply pressurizes the inside of the SOG bottle with N₂ gas. The SOG bottle is connected to SOG tube. In a key feature, a capacitive sensor is mounted on the SOG tube. The capacitive sensor detects gas bubbles in the SOG flowing through the SOG tube. The SOG tube is connected to a nozzle, the SOG flows through the nozzle over to a wafer. The Sensor can be connected to a circuit to alert an operator or to shut down the tool with bubbles are detected.

In addition, the capacitive sensor is preferably a capacitive sensor manufactured by Rechner Electronic Industries Inc, and is Model KAS-40-18/5-N. The SOG tube is preferably comprised of PTFE.

Additional objects and advantages of the invention will be set forth in the description that follows, and in part will be obvious from the description, or may be learned by practice of the invention. The objects and advantages of the invention may be realized and obtained by means of instrumentalities and combinations particularly pointed out in the append claims.

### BRIEF DESCRIPTION OF THE DRAWINGS

The features and advantages of a semiconductor device according to the present invention and further details of a process of fabricating such a semiconductor device in accordance with the present invention will be more clearly understood from the following description taken in conjunction with the accompanying drawings in which like reference numerals designate similar or corresponding elements, regions and portions and in which:

FIG. 1 is a schematic view of the SOG system that has the capacitive sensor according to the present invention.

FIG. 2 is a side view of the capacitive sensor of the present invention mounted on a SOG tube.

FIG. 3 is a front view of the capacitive sensor of the present invention mounted on a SOG tube.

### DETAILED DESCRIPTION OF THE PREFERRED EMBODIMENTS

The present invention will be described in detail with reference to the accompanying drawings. The present invention provides a capacitive sensor for detecting gas bubbles in a SOG line.

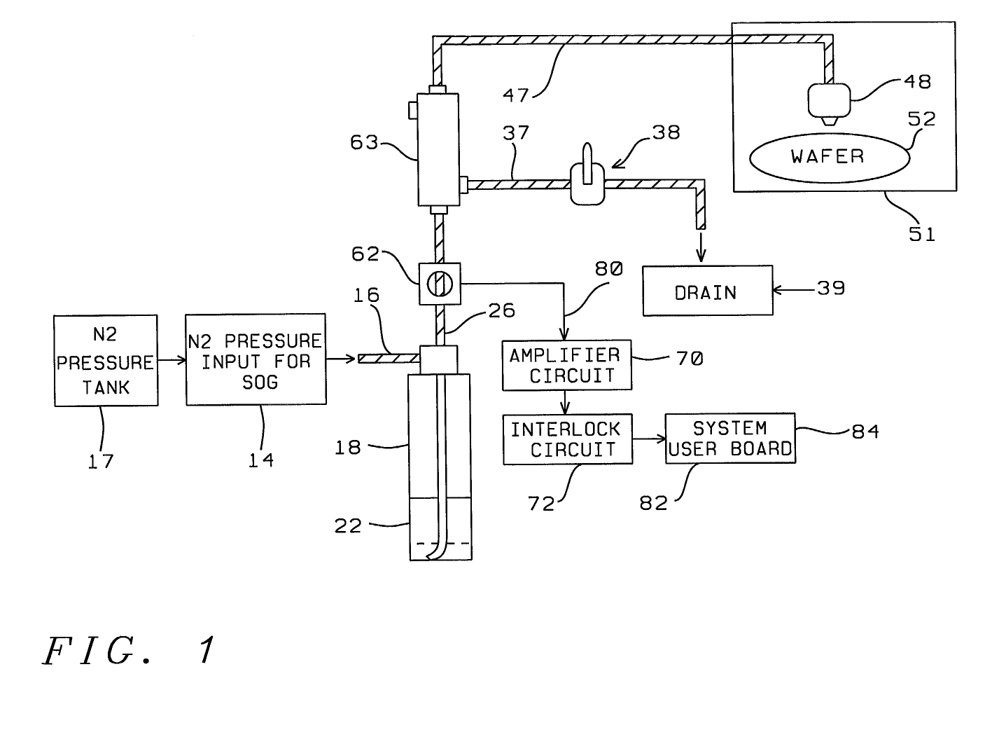

### A. Overview of the SOG delivery system - FIG. 1

A key point of the invention is to use a capacitive sensor 62 to detect gas bubbles in spin-on-glass flowing through a SOG tube. This is a new, unsuggested use for a capacitive sensor. The prior art sensors are optical sensors. The manufactures of the capacitive sensors do not suggest using the capacitive sensors to detect gas bubble in SOG flows. To the applicant's knowledge, no one in the industry uses capacitive sensors to monitor bubble in SOG flows. Capacitive sensor are only used to measure liquid levels in tanks.

Referring to FIG. 1, a spin-on-glass delivery system has the invention's a capacitive sensor to detect gas bubbles in a SOG tube.

A SOG bottle 18 is provided. The SOG bottle contains spin-on-glass (SOG) 22.

A N₂ gas supply 14 is connected to the pressure tank 17 by a pressure tube 16 wherein the N₂ gas supply 14 pressurizes the inside of the SOG bottle with N₂ gas.

The SOG bottle 18 is connected to SOG tube 26.

In a key feature, a capacitive sensor 62 is mounted on the SOG tube 26. The capacitive sensor 62 is inside the SOG tool cabinet. The capacitive sensor 62 detects gas bubbles in the SOG flowing through the SOG tube 26 47.

The gas bubbles in the SOG come from the N₂ supply that pressurizes the inside of the SOG bottle.

The SOG tube is connected to a nozzle 48, the SOG flows through the nozzle over to a wafer 52.

FIG. 1 shows a filter 63 that is connected to the SOG tubes 26 47. The SOG tube 47 is connected to SOG tool 51 and is in some way connected to the nozzle 48. This connection may be made by various tubings/valvings within the SOG tool 51.

The filter can have a drain line 37 connected to a drain valve 38 connected to a drain 39. The drain valve is used to drain out the bubbles trapped inside the filter 63.

Still referring to FIG. 1, the SOG 22 flows through the SOG tube 26 passed the capacitive sensor unit 62 through the filter 63, through the tube 47 into the tool 51, through the nozzle 48 and over a wafer 52.

The capacitive sensor 62 is connected to an interlock circuit 72 via amplifier circuit 70 preferably by line 80. The interlock circuit 72 is connected to a system board 84 by a line 82(Interlock board line). The system board notifies an operator when the capacitive sensor detects gas bubbles in SOG flowing through a SOG tube.

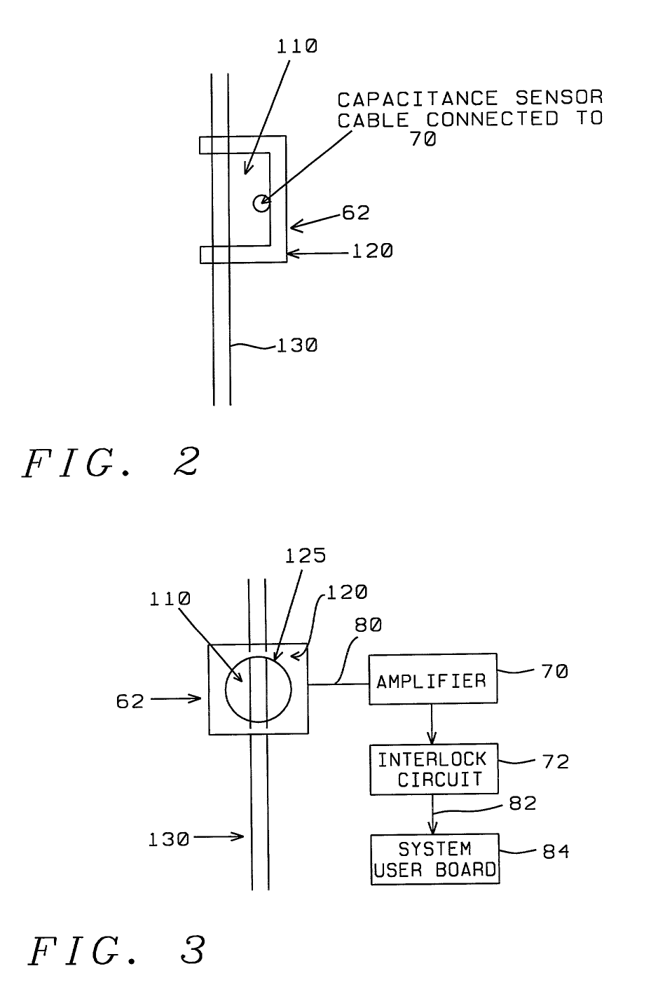

### B. Capacitive Sensor - FIGS. 2 and 3

FIG. 2 is a side view of the capacitive sensor unit 62 mounted on a SOG tube.

The capacitive sensor 62 is connected to the amplifier 70 by line 80 (see FIGS. 1 and 2).

FIG. 3 is a front view of the capacitive sensor unit 62 of the present invention mounted on a SOG tube 130.

The capacitive sensor used by this invention for detecting air or bubbles in the SOG tube(PTFE) are made by: Rechner Electronic Industries Inc. (Model KAS-40-18/5-N).

The invention's capacitive sensor has better detection sensitivity compared to the prior art's optical sensor. The invention's capacitive sensor measures medium change (by means of dielectric constants change of the SOG or any others fluid material compared to gases). In contrast, the prior art optical sensors measure by light emitting means and receiving theory in which SOG material is transparent. However the optical sensors are difficult to calibrate and have difficulty detecting presence of air or bubbles in the transparent tube (PTFE).

FIGS. 2 and 3 show the capacitive sensor or detector unit 62 includes housing 120 (Transparent plastic holder) for holding the capacitance sensor 110 and the SOG tube 130 in predetermined relative positions. The capacitive sensor 110 sensing area is exposed and located parallel to the tubing 130 where bubbles are to be detected.

The SOG tube is preferably comprised of Teflon™ or PTFE and is most preferably comprised of PTFE. The PTFE SOG tube preferably has outside diameter of between about 2.8 and and 3.2 mm and an internal diameter between about 1.8 and 2.2 mm.

FIG. 3 shows the open circular area 125 for the capacitive sensor. The capacitive sensor comes with an amplifier 70 (TS-120-NPN-A) connected to the interlock circuit 72 and the interface with the system user board 84.

### C. Capacitive sensor - detailed description

In addition, the capacitive sensor is preferably a capacitive sensor and amplifier manufactured by Rechner Electronic Industries Inc, and is Model KAS-40-18/5-N & (amplifier=T S-120-NPN-A). Model KAS-40-18/5-N is a type DC capacitive sensor. The amplifier (T S-120-NPN-A) is a PNP output type.

The invention can use a commercially available capacitance detector, but the detector is preferably calibrated for SOG or any others fluid that is being monitored.

LEDs are present on the amplifier (TS-120-NPN-A). Red indicates no bubble present and Green LED indicates that bubbles are present.

The steps to calibrate the sensor are:

1) purge away SOG from the tubing.

2) tune the sensitive pot on the amplifier until the Green LED turns on.

3) Then fill the tubing with SOG and verify that the red LED turns on.

The detector is positioned to detect the dielectric constant of the combination of the tube, the SOG, and any bubbles in the SOG. The dielectric constant of the bubbles is lower than the dielectric constant of the SOG

The sensor 110 is connected to an interlock circuit 72 via an amplifier 70. When bubbles are detected by the capacitor sensor unit 62, a signal is sent to the interlock circuit via the amplifier 70. The interlock circuit 72 can be connected (by line 82) to a system user board 84. This can alert the personal operating the SOG tool (51, see FIG. 1) or shut down the tool.

The dielectric constants of the SOG and the tube 130 are sufficiently different from the dielectric constant of air bubbles that makes it possible to detect the bubbles with a commercially available capacitance sensor.

### The effect of the dielectric constant

The bubble detector 62 responds to the difference in dielectric constant between the bubbles and the SOG. The SOG bubbles are air (or nitrogen) , which has a dielectric constant of about 1, which is low in relation to the other materials that are relevant to this explanation. The dielectric constant of the PTFE tube is about 2, and the dielectric constant of the SOG is about 3.8.

Note that capacitive sensors are used as liquid level sensors, but not as the invention's bubble detector. No manufacturer is known to use or suggest the invention's new use of the capacitive sensor as a bubble sensor.

The wafer 52 can represent a Semiconductor Structure. The Semiconductor Structure is understood to possibly include a semiconductor wafer, active and passive devices formed within the wafer; and insulating and conductive layers formed on the wafer surface.

While the invention has been particularly shown and described with reference to the preferred embodiments thereof, it will be understood by those skilled in the art that various changes in form and details may be made without departing from the spirit and scope of the invention. It is intended to cover various modifications and similar arrangements and procedures, and the scope of the appended claims therefore should be accorded the broadest interpretation so as to encompass all such modifications and similar arrangements and procedures.

What is claimed is:

1. A spin-on-glass delivery system having a capacitive sensor to detect gas bubbles in a SOG tube comprising:
a) a spin-on-glass (SOG) tube connected to a SOG tool;
b) a capacitive sensor mounted on said SOG tube wherein said capacitive sensor detects gas bubbles in SOG flowing through said SOG tube.

2. The method of claim 1 which further includes: said capacitive sensor is connected to an amplifier; said amplifier is connected to an inter lock circuit; said interlock circuit is connected to a system board wherein said system board notifies an operator when the capacitive sensor detects gas bubbles.

3. The SOG delivery system of claim 1 wherein said capacitive sensor is a capacitive sensor manufactured by Rechner Electronic Industries Inc, and is Model KAS-40-18/5-n.

4. The SOG delivery system of claim 1 wherein said capacitive sensor is a DC type capacitive sensor .

5. The SOG delivery system of claim 1 wherein said SOG tube is comprised of PTFE.

6. A spin-on-glass delivery system having a capacitive sensor to detect gas bubbles in a SOG tube comprising:
a) a SOG bottle ; a N₂ gas supply connected to said pressure tank by a pressure tube wherein said N₂ gas supply pressurizes the inside of said SOG bottle with N₂ gas;
b) said SOG bottle contains spin-on-glass;
c) said SOG bottle is connected to SOG tube;
d) a capacitive sensor is mounted on said SOG tube; wherein said capacitive sensor detects gas bubbles in said SOG flowing through said SOG tube.
e) said SOG tube is connected to a nozzle, said SOG flows through said nozzle over to a wafer.

7. The SOG delivery system of claim 6 wherein said capacitive sensor is a capacitive sensor manufactured by Rechner Electronic Industries Inc, and is Model KAS-40-18/5-n.

8. The SOG delivery system of claim 6 wherein said SOG tube is comprised of PTFE.
